(19) United States
(12) Patent Application Publication
(10) Pub. No.: US 2008/0305692 A1
(43) Pub. Date: Dec. 11, 2008

(54) Electrical connector assembly

(75) Inventors: Terrance F. Little, York, PA (US); Kevin E. Walker, Hershey, PA (US); Stephen Sedio, Valley Center, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/810,711

(22) Filed: Jun. 7, 2007

(51) Int. Cl. H01R 24/00

(52) U.S. Cl. 439/676

(57) ABSTRACT

A connector assembly includes a main substrate (20) disposed in a substantially vertical orientation within a connector housing (10). Four conductor-holding halves (301, 303, 401, 403), laterally and longitudinally aligned with each other, are mounted onto opposite front and rear faces of the main substrate for forming a complete upper connector, and a complete lower connector. This arrangement of the upper and lower ports shares a common main substrate, and is optimal from space usage due to having full advantage of opposed face areas defined by the main substrate.

### BACKGROUND OF THE INVENTION

1. Field of the Invention

The present invention relates to the art of electrical connectors, and more particularly to a single- or multi-port connector assembly which may include internal electronic components.

2. Description of the Related Art

Existing modular jack/connector technology commonly utilizes individual discrete components such as choke coils, filters, resistors, capacitors, transformers, and LEDs disposed within the connector to provide the desired functionality. The use of the discrete components causes considerable difficulty in arranging a layout within the connector, especially when considering electrical performance criteria also required by the device. Often, one or more miniature printed circuit boards (PCBs) are used to arrange the components and provide electrical interconnection therebetween. Such PCBs consume a significant amount of space in the connector. Design efforts have been made trying to dispose the one or more PCBs in the connector housing in various way while not compromising electrical performance. At least in the case of disposing multiple PCBs, however, the manufacturing cost of the connector will increase.

U.S. Pat. No. 6,872,098 issued to Wojtacki et al. on Mar. 29, 2005 discloses such a connector assembly. The connector assembly includes two PCBs mounted orthogonally relative to a conductor-holding member. The conductor-holding member, belonging to a stacked connector, respectively interconnects the two PCBs, which have signal conditioning components thereon. Most of the signal conditioning components are disposed on opposite internal faces of the at least two PCBs. In the interior volume of the connector, the ratio of usable volume to total volume within the connector is not optimized.

U.S. Pat. No. 6,773,302 issued to Gutierrez et al. on Aug. 10, 2004 exemplifies a multi-port connector assembly having a plurality of PCBs disposed in a vertical orientation with respect to a front face of the connector housing. In this configuration, a row of conductors usable in a single connector shares a single PCB, which also has the signal conditioning components thereon. This arrangement, however, is also not optimal in space usage in that each row of the upper and lower conductors within the respective connectors is merely disposed on one of the opposite internal faces of two adjacent PCBs.

Therefore, there is a need to provide a connector assembly to resolve the above-mentioned problem.

### SUMMARY OF THE INVENTION

A connector assembly according to an embodiment of the present invention includes a connector housing, a main substrate, and upper left and upper right conductor-holding halves and lower left and lower right conductor-holding halves. The main substrate is disposed in a substantially vertical orientation within, and substantially orthogonal to a front face of the housing. The main substrate includes an edge section having a front face, a rear face and a side face extending transverse to the front and rear faces, with the side face adapted to face the connector housing. The main substrate also includes at least one electrically conductive pathway adjacent to the edge section. The upper left and upper right conductor-holding halves and the lower left and lower right conductor-holding halves, laterally and longitudinally aligned with each other, are mounted onto the opposite front and rear faces and adapted to form a complete upper conductor-holding member of an upper connector, and a complete lower conductor-holding member of a lower connector, respectively. An upper row of conductors are disposed within the upper left and upper right conductor-holding halves, and a lower row of conductors disposed within the lower left and lower right conductor-holding halves, the upper and lower rows of conductors being in electrical connection with the at least one electrically conductive pathway of the main substrate. This arrangement of the upper and lower ports shares a common main substrate, and is optimal from space usage due to having full advantage of opposed face areas defined by the main substrate.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is an exploded, perspective view of a connector assembly including a main substrate and upper and lower conductor-holding halves according to an embodiment of the present invention;

FIG. 2 is a perspective view of the main substrate of FIG. 1;

FIG. 3 is a perspective view of the upper conductor-holding halves of FIG. 1 during an over-molding process;

FIG. 4 is a perspective view of the upper conductor-holding halves of FIG. 1 after an over-molding process;

FIG. 5 is another exploded, perspective view of the upper conductor-holding halves of FIG. 4;

FIG. 6 is an assembled, perspective view of the upper and lower conductor-holding halves of FIG. 1;

FIG. 7 is a perspective view showing the upper and lower conductor-holding halves of FIG. 6 for solder tail connection to the main substrate;

FIG. 8 is a side view of the sub-assembly of FIG. 7;

FIG. 9 is an exploded, perspective view showing the sub-assembly of FIG. 7 and a bottom card-edge connector, through which the connector assembly of FIG. 1 is electrically mounted to a mother board;

FIG. 10 is an assembled, perspective view of the sub-assembly of FIG. 9;

FIG. 11 is a cross-sectional view showing the sub-assembly of FIG. 10 mounted within a main connector housing;

FIG. 12 is an assembled, perspective view of upper and lower conductor-holding halves according to a second embodiment of the present invention;

FIG. 13 is a perspective view showing the upper and lower conductor-holding halves of FIG. 12 for surface mount connection to the main substrate;

FIG. 14 is a perspective view showing upper and lower conductor-holding halves for press-fit connection to the main substrate;

FIG. 15 is an exploded, perspective view showing the sub-assembly of substrates according to a second embodiment of the present invention, the sub-assembly of substrates including the main substrate of FIG. 1 and small substrates;

FIG. 16 is an assembled, perspective view of the sub-assembly of substrates of FIG. 15;

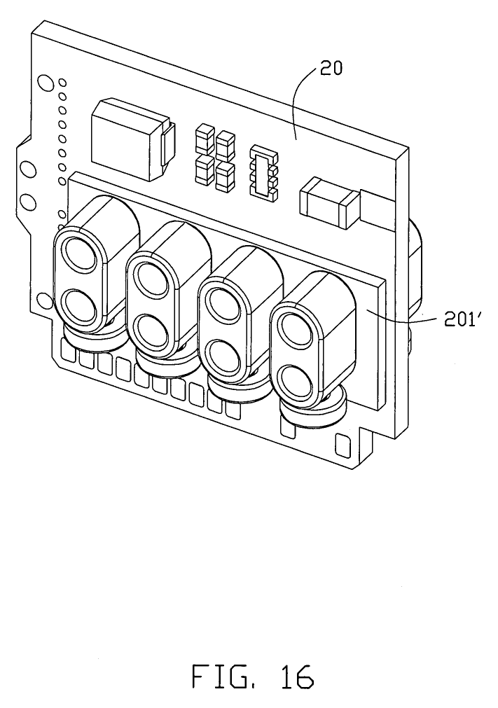

FIG. 17 is an exploded, perspective view showing the sub-assembly of substrates according to a third embodiment of the present invention, the sub-assembly of substrates including two entirely separate substrates; and

FIG. 18 is an assembled, perspective view of the sub-assembly of substrates of FIG. 17.

### DETAILED DESCRIPTION OF PREFERRED EMBODIMENT

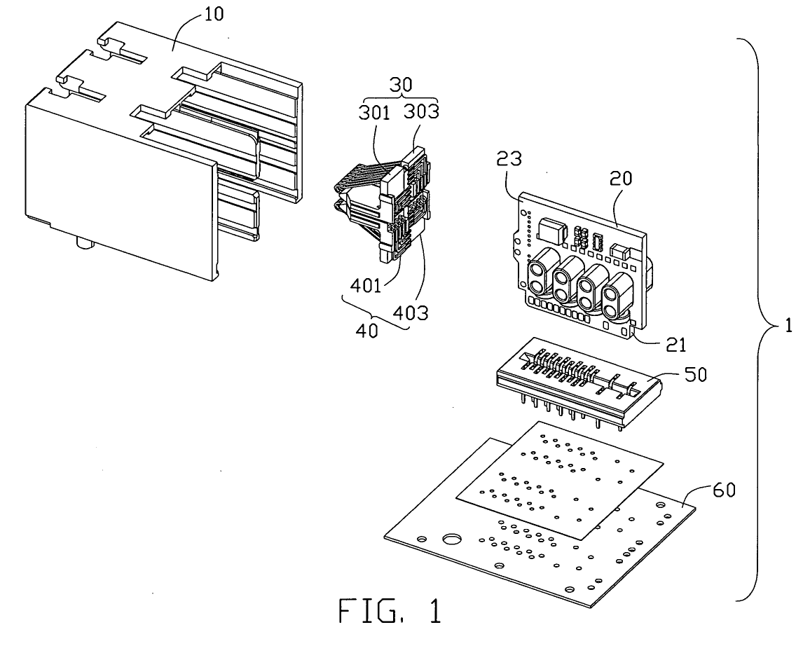

Referring to FIG. 1, a connector assembly 1 according to an embodiment of the present invention includes a connector housing 10, a main substrate 20 disposed in a substantially vertical orientation within and orthogonal to a front face of the connector housing 10, upper left and upper right conductor-holding halves 30, and lower left and lower right conductor-holding halves 40, detachably mounted upon the main substrate 20 respectively (to be later described).

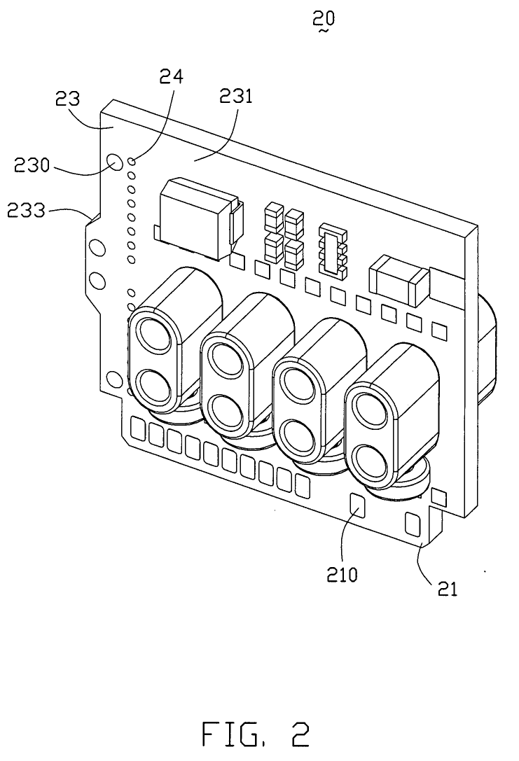

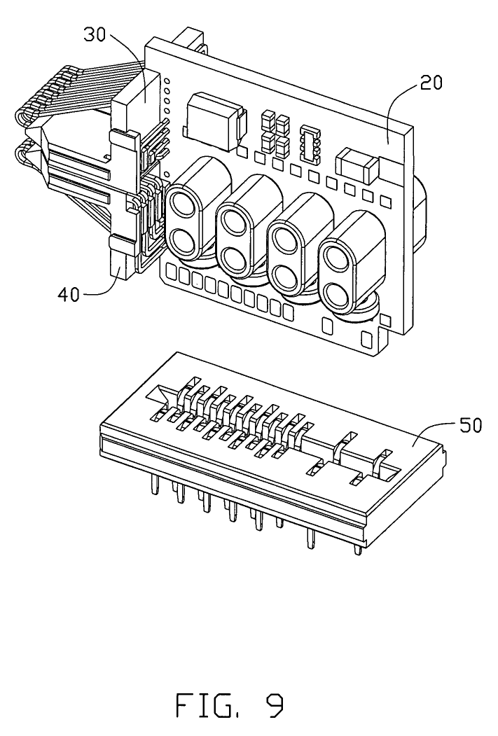

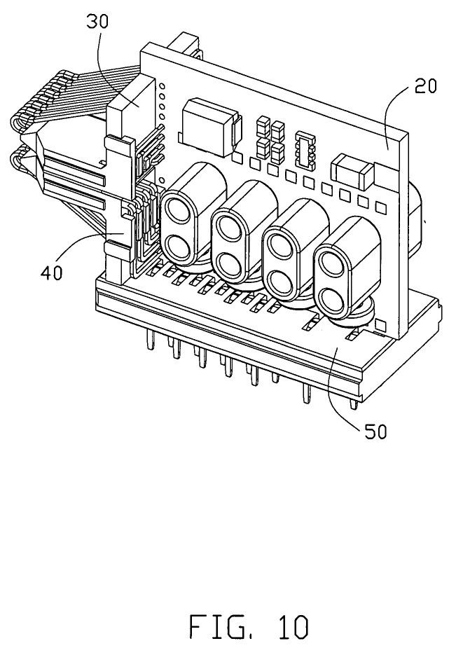

The main substrate 20 defines a lengthwise edge section 21 and a transverse edge section 23 transverse to the lengthwise edge section 21, and includes signal conditioning components mounted on opposite faces around a central region adjacent to the lengthwise and transverse edge sections 21 and 23. The lengthwise edge section 21 is provided with edge contacts 210 (in FIG. 2), through which the main substrate 20 is electrically connected to a bottom card-edge connector 50 and then to a mother-board 60 (see FIGS. 1, 9 and 10). The transverse edge section 23 has a front face 231, an opposite rear face, and a side face 233 extending transverse to the front and rear faces (see FIG. 2). The side face 233 is adapted to face towards the connector housing 10. The transverse edge section 23 of the main substrate 20 is provided with apertures 230 for interengaging elements 311, 313, 411 and 413 (to be later described) to be extended therethrough.

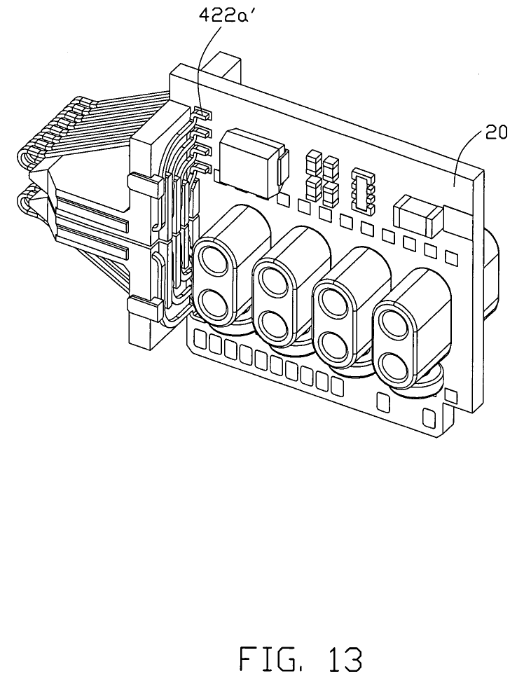

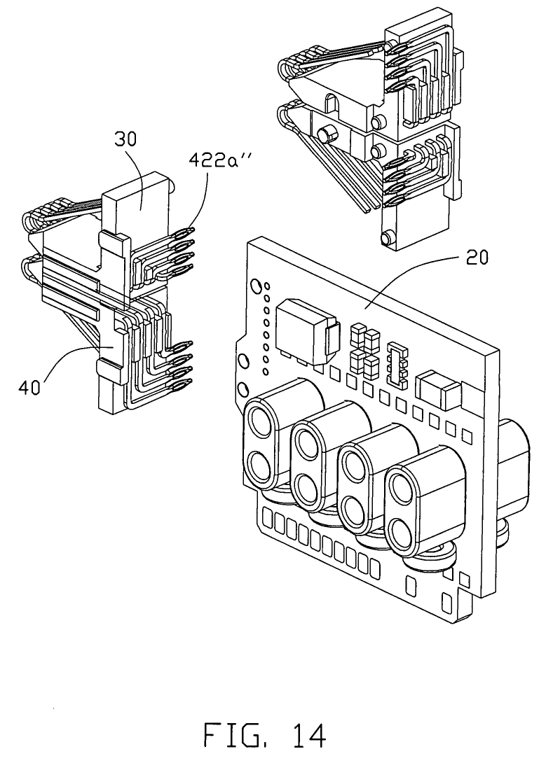

The main substrate 20 is provided with at least one electrically conductive pathway 24 adjacent to the transverse edge section 23. In this embodiment shown in FIG. 2, the at least one electrical conductive pathway 24 is in form of a plurality of metal-plated through holes, which electrically connect with signal conditioning components through the internal circuitry formed across the main substrate 20. Conductors 321, 323, 421 and 423 within the conductor-holding halves are to be solder tail connection to the main substrate 20 through the use of the through holes, thereby resulting in an electrical connection between the conductors 321, 323, 421 and 423, and the at least one electrical conductive pathway 24 of the main substrate 20. However, in an alternative embodiment shown in FIG. 13, the at least one electrical conductive pathway 24 is in form of a plurality of area contacts (not labeled), through which conductors 321′, 323′, 421′ and 423′ within the conductor-holding halves are to be surface mount connection to the main substrate 20. Besides soldering and/or surface mounting, press-fit connection shown in FIG. 14 is also contemplated. That is, the conductors within the conductor-holding halves 30 and 40 include first conductor segments 422a″ for press-fit connection to said main substrate 20.

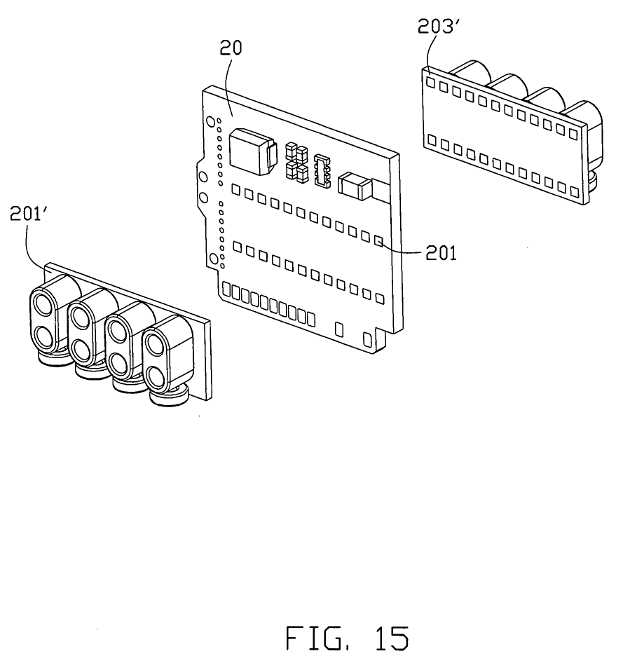

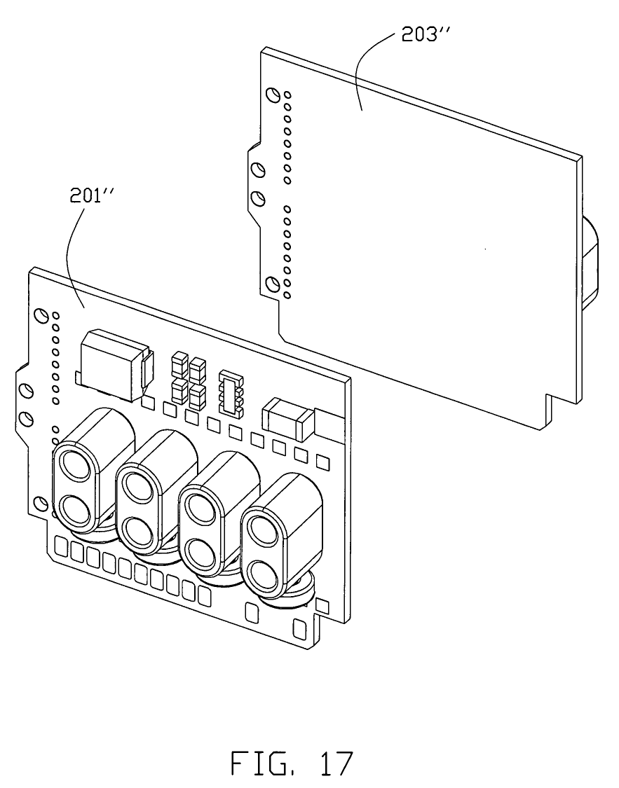

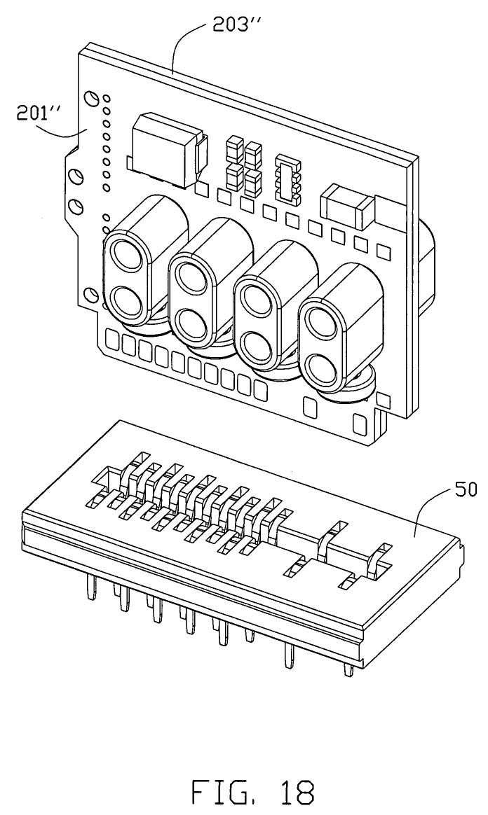

In this embodiment of FIG. 2, the signal conditioning components are divided into two general groups, including such as resistors and capacitors etc. Each group is disposed on one of the opposite faces around the central region of the main substrate 20, with one group for the upper connector and another group for the lower connector. However, in other alternative embodiments, all the signal conditioning components on the opposite faces of the main substrate 20 may be simultaneously shared by the upper and lower ports, without need of being namely divided into two general groups. This arrangement of the signal conditioning components will take full advantage of opposite face areas of the main substrate 20, thereby having an optimal space usage within the connector housing 10. Further, another option for mounting the signal conditioning components is to utilize additional small substrates 201′ and 203′ separable from the main substrate 20 (see FIGS. 14 and 15). The main substrate 20 includes small substrate area contacts 201 for the additional small substrates 201′ and 203′ to be re-flow soldered to the main substrate 20, forming an electrical connection between the main substrate 20 and the signal conditioning components through the small substrates 201′ and 203′. The advantage of utilizing these small additional substrates 201′ and 203′ would be for ease of solderability, whereas the signal conditioning components, such as magnetic torroids, may be soldered separately as a unit. Besides the above option of using the main substrate 20 and the small substrates 201′ and 203′, the option of using two entirely separate substrates 201″ and 203″, as shown in FIGS. 17 and 18, is also contemplated, with every one substrate having the signal conditioning components thereon for each of the upper and lower ports. The two entirely separate substrates 201″ and 203″ are mounted in a back-to-back manner to be inserted into a board-receiving channel formed along a lengthwise direction of the card-edge connector 50.

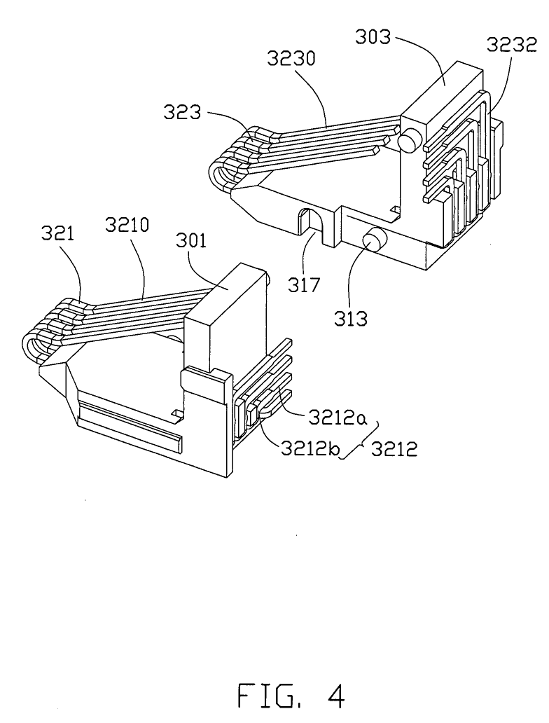

Referring to FIGS. 4 to 6, each of the conductor-holding halves 301, 303, 401 or 403 includes half a row of conductors over-molded therein. That is, the upper left conductor-holding half 301 has half an upper row of conductors 321 disposed therein, and the upper right conductor-holding half 303 has half an upper row of conductors 323, thereby forming a complete conductor-holding member for an upper connector, while the lower left conductor-holding half 401 has half a lower row of conductors 421 disposed therein, and the lower right conductor-holding half 403 has half a lower row of conductors 423, thereby forming a complete conductor-holding member for a lower connector.

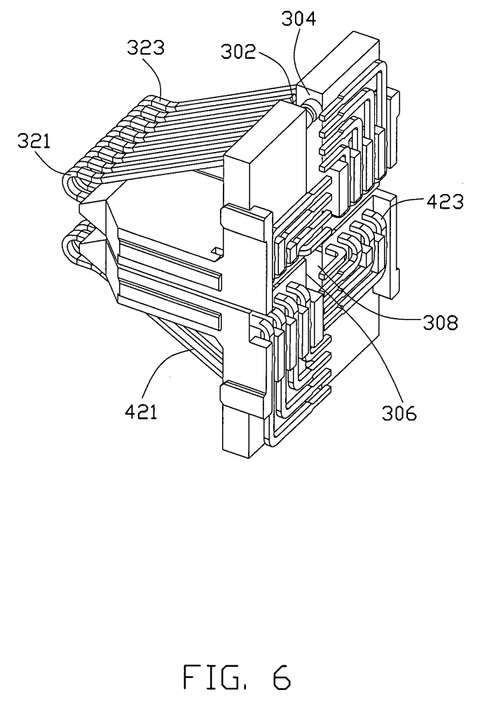

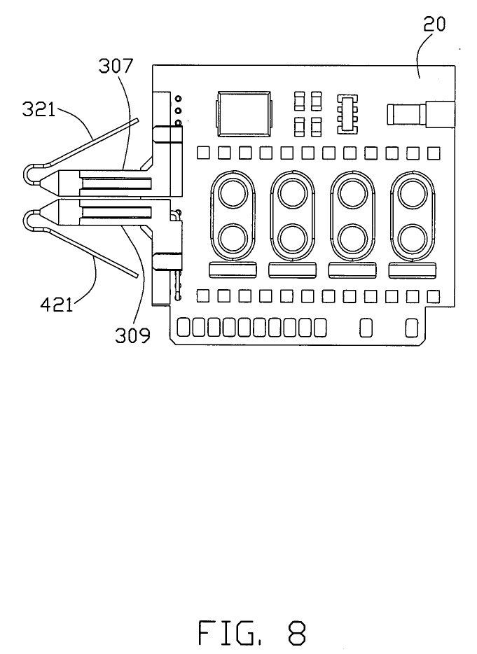

The upper left and upper right conductor-holding halves 301 and 303 define upper front ends, upper rear ends, upper surfaces 307 (see in FIG. 8), and upper interior side edges 302 and 304 (see in FIG. 6) opposite to each other, while the lower left and lower right conductor-holding halves 401 and 403 define lower front ends, lower rear ends, lower surfaces 309 (see in FIG. 8), and lower interior side edges 306 and 308 (see in FIG. 6) opposite to each other. In FIG. 4, the upper row of conductors 321 and 323 on the upper left and upper right conductor-holding halves are configured to extend from the upper front ends towards the upper rear ends. The upper row of conductors 321 and 323, juxtaposed in a row, includes upper jack contact portions 3210 and 3230 extending adjacent to the upper surfaces 307 for mating with a mating plug, and upper printed circuit board contact portions 3212 and 3232 extending adjacent to the opposite upper interior side edges 302 and 304 for electrically engaging with the main substrate 20. In this embodiment, the upper jack contact portions 3210 and 3230 are configured to extend upwardly from the upper surfaces 307, while the upper printed circuit board contact portions 3212 and 3232 are to extend towards the opposite upper interior sides 302 and 304. Similarly, in FIG. 6, the lower row of conductors is configured to extend from the lower front ends towards the lower rear ends. In this embodiment, the lower row of conductors 421, juxtaposed in a row, includes lower jack contact portions extending downwardly from the lower surfaces 309, and lower printed circuit board contact portions extending towards the opposite lower interior sides 306 and 308. In each conductor-holding half, a plane defined by each jack contact portion 3210 or 3230 extends orthogonally relative to a plane defined by each corresponding printed circuit board contact portion 3212 or 3232. Further, as shown in FIG. 8, portions of the conductors 321, 323, 421 and 423 being held by the respective conductor-holding halves extends parallel to the front or rear face of the main substrate 20.

In this embodiment, the respective printed circuit board contact portions 3212 or 3232 (for simplifying the illustration, merely the upper row of conductor labeled) of each conductor-holding half are substantially coplanar and separated from one another. The printed circuit board contact portions 3212 and 3232 within the four conductor-holding halves are arranged such that those of the upper right conductor-holding half 303 are held symmetrical with respect to those of the lower left conductor-holding half 401 relative to a central point defined by the four conductor-holding halves, and those of the upper left conductor-holding half 301 have a symmetry with respect to those of the lower right conductor-holding half 403.

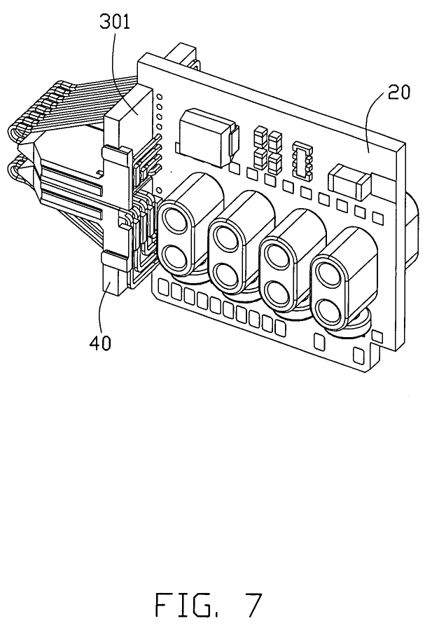

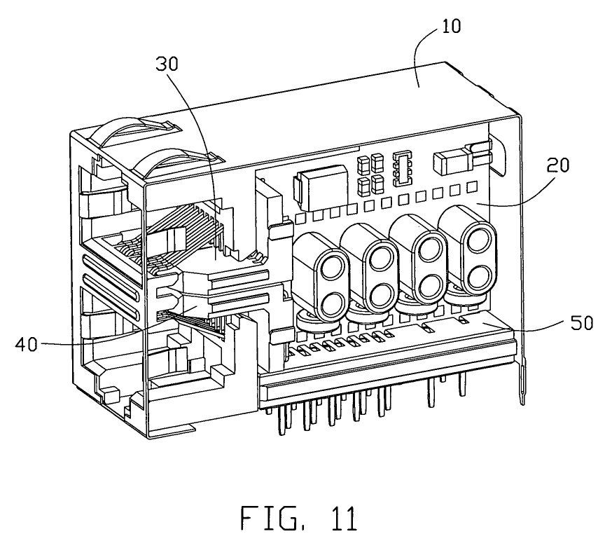

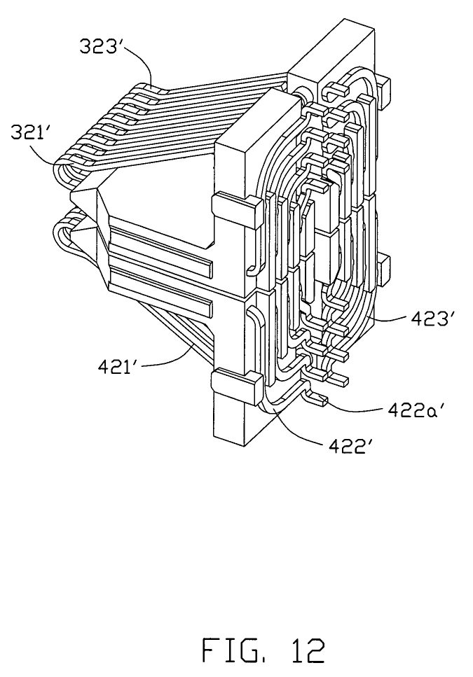

In the first embodiment of FIGS. 1 and 3-11, each of the respective printed circuit board contact portions 3212 includes at least two conductor segments including a first conductor segment 3212a and a second conductor segment 3212b extending at approximately 90 .degree. from the first conductor segment 3212b. The first conductor segment 3212a is oriented substantially normal to the main substrate 20 for the purpose of solder tail connection to the main substrate 20 through the metal-plated through holes. In the second embodiment of FIGS. 12 and 13, each printed circuit board contact portion 422′ (for simplifying the illustration, merely one printed circuit board contact portion labeled) includes three conductor segments having a first conductor segment 422a′, a second conductor segment and a third conductor segment, by forming an angle of 90 .degree. between every two adjacent segments. The first conductor segment 422a′ extends substantially parallel to the front face of the main substrate 20 for surface mount connection to the main substrate 20 through the formation of edge contacts (not labeled) on the main substrate 20.

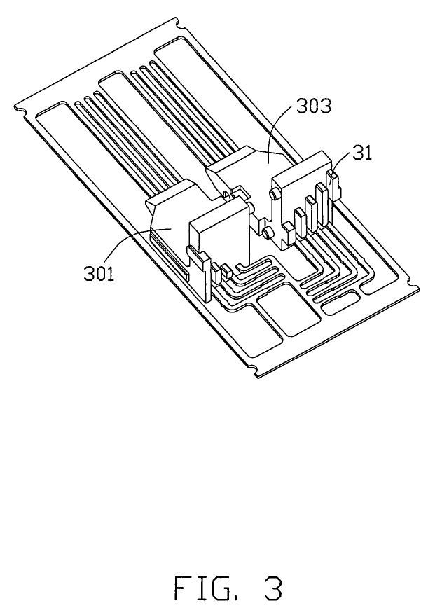

In the above embodiments, each of the conductor-holding halves includes a plurality of grooves 31 (labeled in FIG. 3), by forming a row of ribs thereon, for frictionally receiving at least a portion of the respective printed circuit board contact portions so as to hold the respective conductors 321, 323, 421 and 423 in position. In FIG. 6, the upper left and upper right conductor-holding halves 301 and 303 and the lower left and lower right conductor-holding halves 401 and 403, laterally and longitudinally aligned with each other, are detachably mounted upon the opposite front and rear faces of the main substrate in order to form a complete conductor-holding member for an upper connector, and a complete conductor-holding member for a lower connector. This arrangement will take full advantage of opposed face areas defined by the main substrate 20, thereby having an optimal space usage within the connector housing 10.

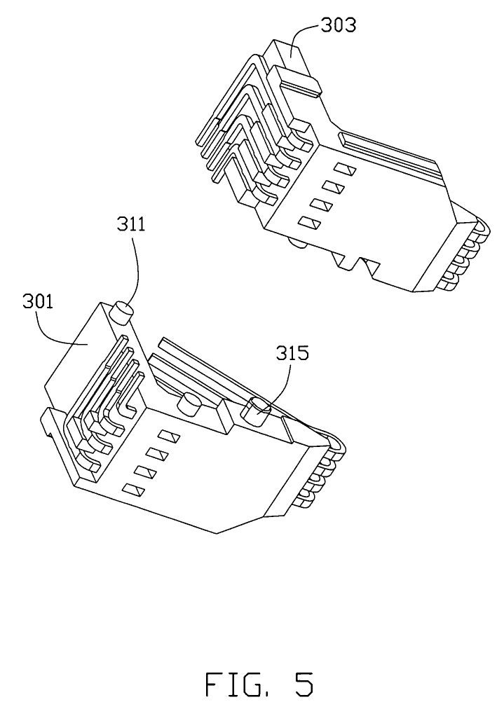

In FIGS. 4 to 7, the upper left and upper right conductor-holding halves 301 and 303 are provided with interengaging elements. The lower left and lower right conductor-holding halves are also formed with interengaging elements. In this embodiment of FIG. 5, the interengaging elements include retaining tabs 311 or 313 extending from one interior side edge of the conductor-holding halves. The conductor-holding halves 301, 303, 401 and 403 are mounted onto the transverse edge section 23 of the main substrate 20 by the interengaging elements extending through the corresponding apertures 230 of the main substrate 20. Additionally, interengaging element in the form of a post 315, preferably with crushing rib, for example on half 301 and a receiving hole 317 for example on half 303 may be provided to interengage the two upper or lower halves.

Referring to FIGS. 1, 7 and 9, in assembly, the upper left and upper right conductor-holding halves 301 and 303, the lower left and lower right conductor-holding halves 401 and 403, laterally and longitudinally aligned with each other, are detachably mounted upon the opposite front and rear faces of the transverse edge section 23 of the main substrate 20 by the interengaging elements through the apertures 230 of the main substrate 20. The conductors 321, 323, 421 and 423 of the four conductor-holding halves are to be solder tail connection or surface mount connection to the at least one electrically conductive pathway of the main substrate 20, thereby forming an electrical connection between the upper and lower ports, and the main substrate 20. The subassembly of the conductor-holding member and the main substrate 20 is then mounted within the bottom card-edge connector 50 by the lengthwise edge section 21 of the main substrate 20 insertable into the board-receiving channel formed along a lengthwise direction of the card-edge connector 50, thereby forming an electrical connection between the main substrate 20 and the bottom card-edge connector 50. The subassembly of the conductor-holding member, the main substrate 20 and the bottom card-edge connector 50 is then at least partly mounted within the connector housing 10 for completing the upper and lower ports.

As stated above, the connector assembly of this embodiment is configured to have the upper conductor-holding member, comprised of the upper left and upper right conductor-holding halves 301 and 303, for the upper connector, and the lower conductor-holding member, comprised of the lower left and lower right conductor-holding halves 401 and 403, for the lower connector, thereby resulting in dual port connectors. This arrangement of the upper and lower ports shares a common main substrate 20, and is optimal from space usage due to having full advantage of opposed face areas defined by the main substrate 20. It should be noted that the above configuration may be not only employed in a single connector, which is formed by left and right conductor-holding halves, and but also in a multi-port connector assembly, which includes a plurality of side-by-side disposed connector sub-assemblies each including the dual port connectors as described above.

While the present invention has been described with reference to preferred embodiments, the description of the invention is illustrative and is not to be construed as limiting the invention. Various modifications of the present invention can be made to preferred embodiments by those skilled in the art without departing from the true spirit and scope of the invention as defined by the appended claims.

What is claimed is:

1. A connector assembly comprising:
a connector housing having a front face;
a main substrate disposed in a substantially vertical orientation within, and substantially orthogonal to the front face of, said housing, said main substrate defining an edge section and including at least one electrically conductive pathway associated therewith;
first and second conductor-holding halves laterally aligned with each other and mounted to opposite faces of said edge section respectively for forming a complete conductor-holding member; and
first and second conductors respectively disposed within said first and second conductor-holding halves and electrically connecting with said at least one electrically conductive pathway of said main substrate.

2. The connector assembly of claim 1, wherein said first and second conductor-holding halves are provided with interengaging elements for laterally engaging said first conductor-holding half with said second conductor-holding half.

3. The connector assembly of claim 1, wherein said first and second conductor-holding halves are provided with interengaging elements for laterally engaging said main substrate.

4. The connector assembly of claim 1, wherein said first and second conductor-holding halves have front ends, rear ends, upper surfaces, and interior side edges opposite to each other, said first and second conductors extending from said front ends towards said rear ends, said first and second conductors including respective jack contact portions extending upwardly from said upper surfaces, and respective printed circuit board contact portions extending towards said opposite side edges.

5. The connector assembly of claim 4, wherein each of said respective printed circuit board contact portions includes a first conductor segment oriented substantially normal to said main substrate for solder tail connection to said main substrate.

6. The connector assembly of claim 4, wherein each of said respective printed circuit board contact portions includes a first conductor segment for surface mount connection to said main substrate.

7. The connector assembly of claim 4, wherein each of said respective printed circuit board contact portions includes a first conductor segment for press-fit connection to said main substrate.

8. The connector assembly of claim 1, further comprising small substrates having additional signal conditioning components mounted thereon, said main substrate having small substrate area contacts for said small substrates to be soldered thereon.

9. The connector assembly of claim 1, further comprising another large substrate separate from said main substrate, said main substrate and said large substrate mounted in a back-to-back manner to have signal conditioning components on two opposite faces of said main substrate and said large substrate.

10. A connector assembly comprising:
a connector housing having a front face;
a main substrate disposed in a substantially vertical orientation within, and substantially orthogonal to the front face of, said housing, said main substrate including an edge section, said main substrate including at least one electrically conductive pathway adjacent to said edge section;
upper left and upper right conductor-holding halves and lower left and lower right conductor-holding halves, laterally and longitudinally aligned with each other, mounted onto opposite faces of the edge section and adapted to form a complete upper conductor-holding member and a complete lower conductor-holding member, respectively; and
an upper row of conductors disposed within said upper left and upper right conductor-holding halves, and a lower row of conductors disposed within said lower left and lower right conductor-holding halves, said upper and lower rows of conductors being in electrical connection with said at least one electrically conductive pathway of said main substrate.

11. The connector assembly of claim 10, wherein said upper left and upper right conductor-holding halves are provided with upper interengaging elements for laterally interengaging with each other, said lower left and right conductor-holding halves are provided with lower interengaging elements for laterally interengaging with each other.

12. The connector assembly of claim 10, wherein said first and second conductor-holding halves are provided with interengaging elements for laterally engaging said main substrate.

13. The connector assembly of claim 10, wherein said upper left and upper right conductor-holding halves have upper surfaces, and upper interior side edges opposite to each other, said upper row of conductors including respective jack contact portions extending upwardly from said upper surfaces, and respective printed circuit board contact portions extending towards said opposite upper interior side edges.

14. The connector assembly of claim 13, wherein said lower left and lower right conductor-holding halves have lower surfaces, and lower interior side edges opposite to each other, said lower row of conductors including respective jack contact portions downwardly from said lower surfaces, and respective printed circuit board contact portions extending towards said opposite lower interior side edges.

15. The connector assembly of claim 10, further comprising small substrates having additional signal conditioning components mounted thereon, said main substrate having small substrate area contacts for said small substrates to be soldered thereon.

16. The connector assembly of claim 10, further comprising another large substrate separate from said main substrate, said main substrate and said large substrate mounted in a back-to-back manner to have signal conditioning components on two opposite faces of said main substrate and said large substrate.

17. An electrical connector assembly comprising:
an insulative housing defining a plug receiving cavity therein;
a plurality of contacts disposed in the housing, each of said contacts defining a first horizontal section extending along a front-to-back direction, a spring contacting section obliquely and rearwardly extending from a front end of the first horizontal section and into the plug receiving cavity for mechanically and electrically connected to corresponding terminals of a plug which is inserted into the plug receiving cavity, a board mount end secured to a printed circuit board, and a connection section linked between the board mount end and a rear end of the first horizontal section; and
an insulative contact holder retaining said plurality of contacts therein; wherein
said first horizontal sections of said plurality of contacts are located in a horizontal plane extending along said front-to-back direction, said printed circuit board is located in a first vertical plane extend along a firs plane, said connection sections of said plurality of contacts are located in a second vertical plane perpendicular to both said horizontal plane and said first vertical plane, said spring contacting sections are commonly located in a same oblique plane which is oblique to both said horizontal plane and said second vertical plane while perpendicular to said first vertical plane.

18. The electrical connector assembly of claim 17, wherein said connection section includes a vertical section extending from the rear end of the first horizontal section of the corresponding contact in a vertical direction perpendicular to said front-to-back direction, and a second horizontal section transversely extending from an end of said vertical direction in a horizontal direction perpendicular to both said front-to-back direction and said vertical direction.

19. The electrical connector assembly of claim 18, wherein said board mount end extends in alignment with the second horizontal section of the corresponding contact.

20. The electrical connector assembly of claim 17, further including another contact holder retaining another plurality of contacts therein, wherein said another contact holder cooperates with said contact holder to sandwich said printed circuit board under a condition that the first horizontal sections and the spring contacting sections of both said contact holders are arranged similar to each other in a mirror image while the connection sections of said two contact holder are arranged complementary with each other.
